(19) United States
(12) Patent Application Publication
(10) Pub. No.: US 2015/0120404 A1
(43) Pub. Date: Apr. 30, 2015

(54) Method and Apparatus For Providing Information Related to an Offer to at Least One Mobile User

(71) Applicant: Telefonaktiebolaget L M Ericsson (publ), Stockholm (SE)

(72) Inventors: Matthew John LAWRENSON, Lausanne (CH); Julian Charles Nolan, Lausanne (CH)

(73) Assignee: Telefonaktiebolaget L M Ericsson (publ), Stockholm (SE)

(21) Appl. No.: 14/066,046

(22) Filed: Oct. 29, 2013

Related U.S. Application Data
(63) Continuation of application No. PCT/EP2013/072594, filed on Oct. 29, 2013.

(51) Int. Cl. G06Q 30/02

(52) U.S. Cl. CPC G06Q 30/0207
USPC 705/14.1

(57) ABSTRACT

This disclosure relates to a method, performed in a computer-based apparatus (1) for providing information (S2) related to an offer to at least one mobile user (2), being positioned at a first position (A), from an offering entity (2) being positioned at a second position (B), said offer being associated with a compensation to the user (2) upon fulfillment (S9) of an offer objective by said user (2). The method comprises: providing information (S8) related to said offer objective from said offering entity (3) to said user (2); detecting whether said offer objective has been fulfilled (S9) by said user (2); transferring (S10) said compensation from said offering entity (3) to said user (2) when said offer objective offer has been fulfilled by said user (2); said compensation being transferred in the form of a credit related to a calculated offer value (S6) corresponding to the cost for said user (2) for travelling between said first position (A) and said second position (B). The disclosure also relates to a computer-based apparatus for providing transfer of information related to an offer objective.

### TECHNICAL FIELD

The present disclosure pertains to the field of providing information related to an offer to at least one mobile user, being positioned at a first position, from an offering entity being positioned at a second position. The offer objective is associated with a compensation to the user upon fulfillment of an offer objective by said user. The disclosure further pertains to a corresponding apparatus.

### BACKGROUND

Commercial entities such as shops, restaurants and similar enterprises, which offer products and services on a market, may propose discounts, price reductions and similar offers to their potential customers. Information regarding such offers can be distributed for example by means of conventional discount coupons or by distributing other forms of advertisement, in order to encourage potential customers to visit a shop or a similar point of sale for making purchases.

For example, it is common for commercial entities to issue discounts which offer a certain reduced price or discount on a particular product on offer. For example, a commercial entity may offer its prospective clients a 10% discount if they buy a “Product X” in their shop. Consequently, this means that the potential customer is faced with an offer objective, i.e. in this case visit a particular point of sale or checkout and then purchase “Product X”.

An offering entity such as a shop consequently approaches the potential customer with an offer, for example a discount on a certain price of a product, and an offer objective, which for example corresponds to purchasing the product at a shop being associated with the entity in question. Once this offer objective has been met, the customer is rewarded with some form of compensation, for example a set discount on the price of the product.

Traditional paper coupons or other sales information such as advertisements can be distributed by mail or by printing them in newspapers. A disadvantage with this type of offer is that the distribution is expensive and slow, and may not reach a sufficient number of potential customers. Also, in the case of a coupon, it must be retained as a physical item and presented when making a purchase at a retailer or another commercial entity.

For the purpose of improving the traditional technique, so-called “virtual”, or digital coupons have been developed. The patent document US 2012/0136706 teaches a digital coupon system in which digital coupons are issued by a commercial entity and distributed to a number of users. A coupon can then be redeemed when a customer makes a purchase.

The existing system as mentioned has limitations in the sense that a specific digital coupon is associated with the purchase of a product and for this reason may be limited and non-flexible with regard to its use. Also, such a digital coupon may not always be targeted in an optimal manner at specific types or categories of customers.

With the above in mind, it is a purpose of the invention to provide a platform for providing transfer of information related to an offer objective which is more flexible and useful than previous solutions.

### SUMMARY

An object of the present disclosure is to address the disadvantages mentioned above in connection with prior art and provide an improved method by means of which a flexible and cost-effective transfer of information related to an offer objective can be obtained.

This object is obtained by a method, performed in a computer-based apparatus for providing information related to an offer to at least one mobile user, being positioned at a first position, from an offering entity being positioned at a second position, said offer being associated with a compensation to the user upon fulfillment of an offer objective by said user. The method comprises: providing information related to said offer objective from said offering entity to said user; detecting whether said offer objective has been fulfilled by said user; transferring said compensation from said offering entity to said user when said offer objective offer has been fulfilled by said use); said compensation being transferred in the form of a credit related to a calculated offer value corresponding to the cost for said user for travelling between said first position and said second position.

This technique offers an advantage in the sense that the offering entity has a possibility of encouraging a mobile user, which is a potential customer, to travel to the premises of the offering entity (for example to a shop or a restaurant with a point of sale such as a checkout desk) in order to fulfill the offer objective. This is obviously commercially attractive for the offering entity since it provides increased and more flexible opportunities for sales. In particular, in today's society wherein many peoples' lives are dominated by vehicle transports, the present technique may be used for encouraging the use of vehicles to travel to the premises of the offering entity for making purchases or other commercial activities.

According to one aspect of the disclosure, the method comprises calculating said offer value by taking into account a cost of energy for said user to travel between said first position and said second position. This technique provides the advantage of attracting customers, in particular customers driving an electric vehicle, to travel to a physical location of the offering entity while having the cost of energy for charging the vehicle for said travel being refunded.

According to an aspect of the disclosure, the method further comprises calculating said offer value by taking into account a cost of charging an energy source being associated with said user. This means that in the event that the user is a driver of an electric vehicle, there is an opportunity to provide a flexible refunding system wherein the charging of a battery pack or similar on a vehicle corresponds to the actual refund value.

According to a further aspect of the disclosure, the method further comprises calculating said offer value by taking into account a distance for said user to travel between said first position and said second position.

According to yet a further aspect of the disclosure, the method further comprises determining said distance by using navigational information from a GPS system indicating the location of said user (i.e. the first position) and indicating the location of said offering entity (i.e. the second position). The GPS system is used frequently today for navigating, and forms a useful and accurate base for calculating an actual offer value, i.e. corresponding to the worth of fulfilling the offer objective for the user.

According to yet a further aspect of the disclosure, the step of providing information related to said offer objective to said user includes transmitting information related to the second position. This means that the distance between the first location to the second location can be used for calculating the cost for travelling said distance.

According to yet a further aspect of the disclosure, the method further comprises determining whether said offer objective has been fulfilled upon arrival of said user at said second position.

Furthermore, for the purpose of obtaining the above-mentioned object, the disclosure also relates to a computer-based apparatus for providing information related to an offer to at least one mobile user, being positioned at a first position, from an offering entity being positioned at a second position, said offer being associated with a compensation to the user upon fulfillment of an offer objective by said user. The apparatus comprises a communication unit configured for mediating information related to said offer objective between said user and said offering entity and related to said compensation from said offering entity to said user when said offer objective has been fulfilled by said user; a control unit configured for detecting whether said offer objective has been fulfilled by said user; and a calculation unit configured for determining a calculated cost for said user for travelling between said first position and said second position, said offer value being transferred to the user in the form of a credit of said calculated cost.

According to an aspect of the disclosure, the calculation unit is configured for calculating said offer value by taking into account a cost of energy for said user to travel between said first position and said second position. As indicated above, this is an advantage since customers, in particular customers driving an electric vehicle, can be encouraged to travel to a physical location of the offering entity while having the cost of energy for charging the vehicle being refunded.

According to a further aspect, the calculation unit is configured for calculating said offer value by taking into account a cost of charging an energy source being associated with said user.

According to a further aspect, the calculation unit is configured for calculating said offer value by taking into account a distance for said user to travel between said first position and said second position.

According to yet another aspect, the communication unit is configured for communicating with a GPS system indicating the position of said user and indicating the position of said offering entity, wherein said calculation unit is configured for determining said distance by using navigational information from the GPS system.

According to a further aspect, the communication unit is configured for transmitting information related to the second position to said user.

Also, according to a further aspect, the control unit is configured for determining whether said offer objective has been fulfilled upon arrival of said user at said second position.

Furthermore, according to another aspect of the disclosure, it relates to an electric vehicle comprising an apparatus as described above. According to a further aspect, the disclosure relates to a mobile communication unit comprising an apparatus as described above. Finally, according to a further aspect, the disclosure relates to a computer program, comprising computer readable code which, when run on an apparatus, causes the apparatus to perform the method as described above.

With the above description in mind, the object of the present disclosure is to overcome at least some of the disadvantages of known technology as described above and below.

### BRIEF DESCRIPTION OF THE DRAWINGS

Further objects, features, and advantages of the present disclosure will appear from the following detailed description, wherein certain aspects of the disclosure will be described in more detail with reference to the accompanying drawings, in which:

FIG. 1 is a schematical overview of embodiments according to the disclosure; and

FIG. 2 is a flowchart illustrating method steps of the disclosure according to exemplary embodiments.

### DETAILED DESCRIPTION

Aspects of the present disclosure will be described more fully hereinafter with reference to the accompanying drawings. The method and apparatus disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure to any particular embodiment. As used herein, the singular forms “a”, “an” and “the” are intended to include the plural forms as well, unless the context clearly indicates otherwise.

The general object or idea of embodiments of the present disclosure is to address at least one or some of the disadvantages with the prior art described above, in particular as regards the drawbacks related to distribution and useability of previously known discount coupons and similar types of advertisement for products and services. The disclosure proposes improved ways of employing offer objectives for encouraging potential customers to accept an offer and obtaining compensation for meeting the offer objective.

The various steps described below in connection with the figures should be primarily understood in a logical sense, while each step may involve the communication of one or more specific messages depending on the implementation and protocols used.

The general idea of the proposed technique is to allow a mobile user, who is a potential customer, to meet an offer objective issued by an offering entity, so as to be compensated with a value corresponding a calculated cost for said user to travel between an initial, first position, and a second position at which the offer objective can be fulfilled.

In the present disclosure, the term “offer” refers to a proposal of primarily a sales-related or commercial character which can be obtained by a potential customer of a commercial entity which is normally in the form of a shop, restaurant or similar enterprise. An “offer” can also be initiated by a charity organisation, i.e. an offering entity generally without any commercial interest. For example, an offer can be presented to a potential customer in the form of a discount or a commercial or sales-related benefit which can be redeemed with the offering entity. As will be discussed below, a specific offer can be identified by means of an ID.

In the present disclosure, the term “offer objective” refers to specific actions that a user has to fulfill in order to meet the offer and redeem an offer value. In this regard, the offer value corresponds to a sum of money, energy or other forms of goods or services which can be transferred to the user upon fulfillment of the offer objective.

In the present disclosure, the term “offering entity” refers to an enterprise, a commercial company, a charity organisation or another form of legal or physical person who is presenting offers, as explained above, to one or more users.

Furthermore, in the present disclosure, the term “user” refers to a person who enters into an offer process with the offering entity, i.e. a person who has indicated to an offering entity the intention of meeting a certain offer objective which upon fulfillment results in a compensation being credited.

The term “outline offer” as used in the present disclosure refers to the outline conditions of the offer. Outline offer terms may have several specific offers that are able to meet these terms. A specific offer is an offer consisting of a unique set of offer objectives that need to be fulfilled by a user.

The term “energy supplier” as used herein refers to a commercial entity which supplies electric energy to a number of subscribers.

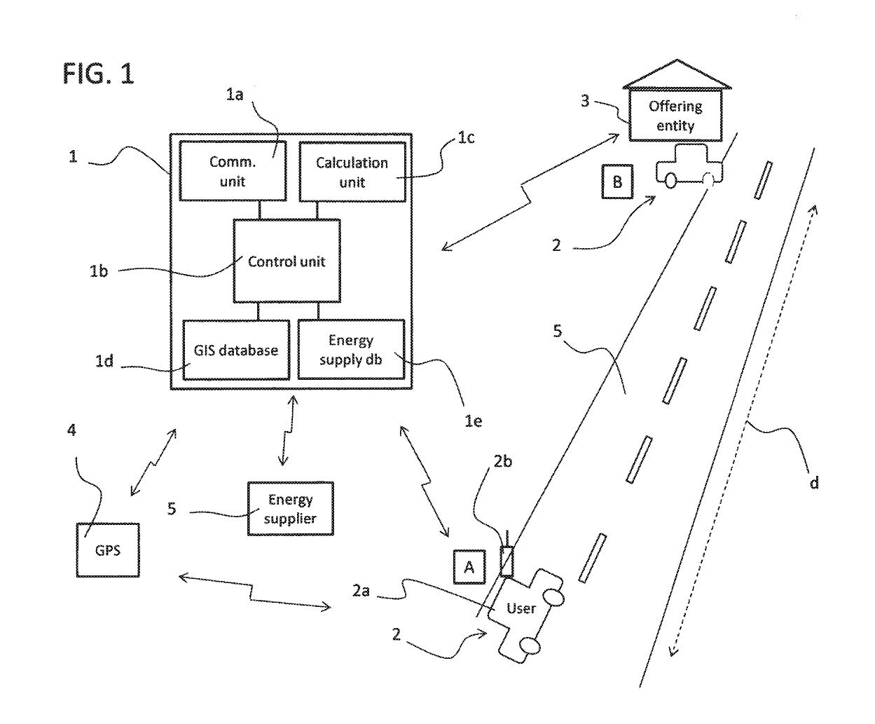

With reference to the appended FIG. 1, and according to an aspect of the disclosure, there is provided a computer-based apparatus 1 which is arranged for providing transfer of information related to an offer objective to a user 2. The computer-based apparatus 1 comprises a communication unit 1a, a control unit 1b, a calculation unit 1c, a geographical information system database 1d and an energy supply database 1e. These units will be further described below.

The user 2 is positioned at a first position A and is mobile in the sense that the user 2 is a person who is able to travel from a first position A to a second position B by means of a vehicle 2a. As shown in FIG. 1, the second position B corresponds to a location being associated with an offering entity 3, which according to an embodiment is a commercial entity such as a company which is offering goods or services to a market and which has the intention of initiating and transmitting data related to a sales-related offer to the mobile user 2.

This aspect of the disclosure describes technology in which the vehicle 2a is constituted by an electric vehicle, i.e. a vehicle such as a car which is configured for propulsion which is at least partly based on the use of one or more electric motors. According to known technology, the term “electric vehicle” can be used to describe a vehicle which for example can be of one of the following types:
a vehicle which is entirely propelled by one or more electric motors (for example one electric motor associated with each wheel of the vehicle) and which carries a rechargeable pack of batteries which can be recharged by means of an external electric power supply, for example a conventional wall socket; or
a so-called electric hybrid vehicle which comprises both a conventional internal combustion engine, i.e. a gasoline or diesel engine, and also an electric propulsion unit.

The technology behind the vehicle types described above are generally known to the skilled person and, for this reason, it is not described in further detail here. For the purpose of describing the aspect of FIG. 1, it is assumed that the vehicle 2a is in the form of an electric vehicle or electric hybrid vehicle. Both of these vehicle types are provided with a pack of rechargeable batteries (not shown in the drawing) and control devices configured for managing charging of the battery pack depending on its state of charge.

As shown in FIG. 1, there is a certain distance d between the first position A and the second position B, i.e. corresponding to the distance between the current position of the user 2 and the position of the offering entity 3. Furthermore, the offering entity 3 has a point of sale, checkout or similar function.

This present disclosure proposes that the mobile user 2 can be presented with an offer from the offering entity 3 which consists of a possibility of being compensated with a calculated cost, i.e. an offer value. The offer is associated with an offer objective, i.e. a pre-defined action or activity which the mobile user 2 must carry out in order to be approved to receive said compensation, i.e. to be credited with said calculated cost.

According to an aspect, the offer objective corresponds to the mobile user 2 travelling to the second position B and making a purchase of a goods or service from the offering entity 3. If this offer objective is fulfilled by the mobile user 2, the compensation is transferred to the mobile user 2. According to the aspect, the compensation is constituted by a discount, for example 10%, of the price of the goods or service in question.

As shown in FIG. 1, the mobile user 2 is associated with a mobile device 2b for communicating with said computer-based apparatus 1. The mobile device 2b is also configured so that information can be received by the mobile user 2 from the offering entity 3, via the computer-based apparatus 1, related to an offer and related to an offer objective. This will be described in further detail below. According to aspects of the disclosure, the mobile device 2b is constituted by a mobile telephone, a tablet computer, a notebook, a laptop computer or other mobile device arranged for communication with at least the computer-based apparatus 1 and the offering entity 3 via a communication network such as a telephone network or other wireless network.

The mobile device 2b is also configured so as to contain information regarding the position of the user 2, i.e. the first position A. According to an aspect, this is obtained through transfer of information from a GPS system (Global Positioning System), which is indicated with reference numeral 4 in FIG. 1. The mobile device 2b and the computer-based apparatus 1 are configured for receiving data from the GPS system 4.

If the mobile user 2 travels from the first location A to the second location B and fulfills the offer objective, this will be detected by the offering entity 3. As a result, the compensation to the mobile user 2 will be transferred from the offering entity 3. Furthermore, the compensation will be transferred in the form of a price reduction or credit corresponding to the calculated cost for the mobile user 2 for travelling from the first position A to the second position B. According to an aspect, the compensation will be in the form of a reduction from a regular purchase price for a certain product or service which the mobile user 2 purchases at a the second location B.

According to an aspect, the calculated cost mentioned above is obtained by taking into account a cost of energy for said user to travel from the first position A to the second position B. The cost of energy normally corresponds to a cost of charging an energy source in the vehicle 2a, wherein the energy source is constituted by a rechargeable pack of battery cells as mentioned above. Said calculated cost can also be obtained by taking into account the distance d between the first position A and the second position (B). According to an aspect, the distance d can be determined by using navigational information from the GPS system 4, which indicates the position of said user 2 and transmits information regarding said position to the mobile device 2b.

According to a further aspect, the energy use, or energy consumption, of the vehicle 2a can be used as further information for determining the cost to be compensated to the user 2. In order to implement this, energy usage data corresponding to a nominal cost per distance unit for the vehicle 2a must be communicated to the computer-based apparatus 1.

In order to describe the embodiment in greater detail, a non-limiting example will now be provided. An offering entity, in this example in the form of a restaurant chain, has an offer whereby a user in the form of a potential restaurant customer can have the cost of travelling from the customer's current location (corresponding to the first position A as mentioned above) to one of the restaurant chain's restaurants (corresponding to the second position B as mentioned above) refunded should the customer purchase a meal corresponding at a predetermined price.

It is now assumed that this customer, i.e. corresponding to the mobile user 2 shown in FIG. 1, accepts the offer and as a result provides details of its location and energy use of their electric vehicle. Based on this information, the offering entity 3 calculates a number of restaurant locations it wishes to add to the selection. From this list the customer selects one restaurant, travels to its location (corresponding to the second position B in FIG. 1) and purchases a meal corresponding to the given price. The payment of the meal at the selected restaurant triggers the fulfillment of the offer objective and initiates a process that returns the cost of energy used in the journey to and from the restaurant to the user 2.

In order to implement the technique according to the disclosure, the computer-based apparatus 1 comprises the communication unit 1a, the control unit 1b, the calculation unit 1c, the GIS database 1d and the energy supply database 1e. The GIS database 1d includes details of road networks from which route information can be determined. The energy supply database 1e contains energy tariffs for one or more energy suppliers, i.e. commercial entities producing and selling electric energy to a number of subscribers. One such energy supplier is indicated with reference numeral 5 in FIG. 1.

The method as described above can be performed in different locations and entities. Firstly, it can be carried out in a “cloud”-based entity, i.e. by means of services provided on demand via a remote location as opposed to a service provider's own on-premises server. A “cloud” location is consequently a remote location which possesses processing and memory storage capability. This corresponds to the general overview presented in FIG. 1.

Alternatively, the method as described can be implemented in a computer-based apparatus 1 which is integrated within the user's 2 mobile device 2a, or alternatively being implemented in a computer-based apparatus 1 associated with the offering entity 3 and located at the premises of the offering entity 3.

Alternatively, the method can be performed in a computer-based apparatus of a type which is distributed, i.e. spread across some or all of the above-mentioned locations.

According to alternatives, the proposed technology may be based on other types of offer objectives to be met by a mobile user, for example the following. The user 2 may be presented with an offer in which the user 2 is compensated with a credit equal to a calculated cost for travelling between the first position A and the second position B. This means that the offer objective is to travel to the second position B and purchase a product at a certain price. Alternatively, the offer objective may be to travel to the second position B and park the vehicle 2a for a certain time period. Alternatively, the offer objective may be to travel to the second position B and visit a guided sightseeing tour or museum. Many other examples may be implemented within the principles of the present disclosure.

The energy consumed by the user 2 depends on various vehicle dependent factors and these can be incorporated to varying degree in the estimation. The offer is presented to the user 2, including details of where the offer can be redeemed, and the offer objective that the user 2 has to fulfill. A step according to an embodiment then detects if the offer objective has been fulfilled and a further step redeems the cost of energy to the user.

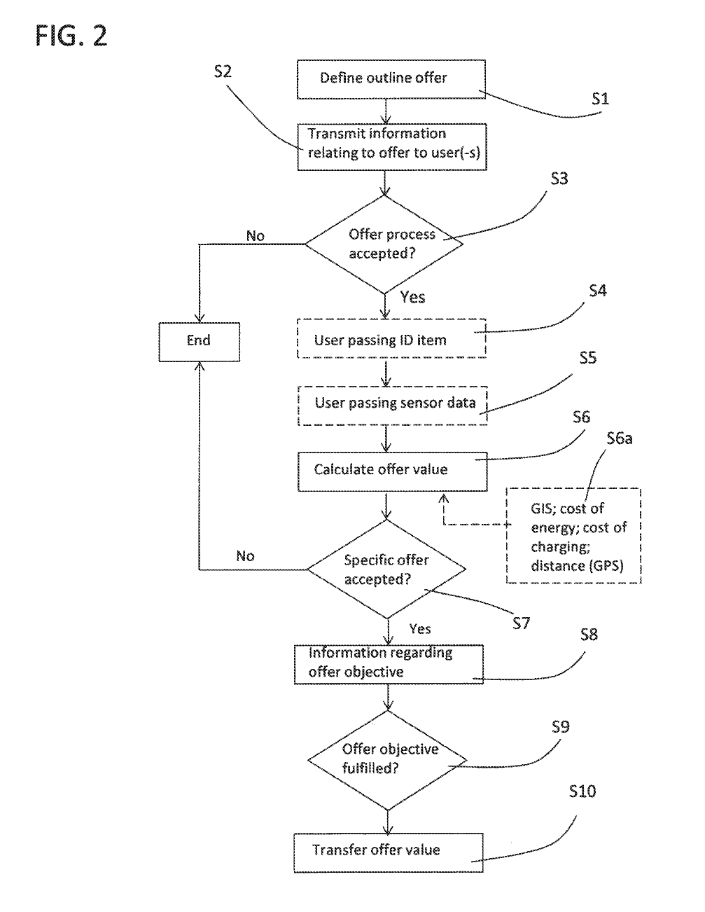

A method for carrying out the above-mentioned aspect will now be described generally with reference to FIG. 2, which is a flowchart corresponding to the description above of the present disclosure.

As an initial process step, referred to as step S1 in FIG. 2, an outline offer is defined by the offering entity 3. According to an aspect, the outline offer defines items such as:
an outline offer ID (i.e. a code identifying the identity of the outline offer);
a maximum value that can be redeemed by the user 2;
at least one particular offer objective that needs to be fulfilled before the transfer of the offer value to the user 2;
the position (or positions) of the offering entity's 3 practice or operations which will participate in the current offer; and
any time limits which are applicable to the offer.

Once the offer has been defined it is presented to a number of potential users, such as the user 2 indicated in FIG. 1. According to aspects of the disclosure, the outline offer could be presented to the user 2 by:
advertisement, e.g. press, internet etc.;
an internet url; or
by use of a special “user code”, which can be given to particularly valued customers.

When the offer has been defined it is presented to potential users, step S2, for example through printed or electronic media or by transmitting information to the mobile device 2b so that the user 2 becomes aware of it.

Once the offer has been presented to the user 2, the user 2 makes an action to signify an interest in entering into the offer process and a desire to know more details about the specific offer. According to aspects of the disclosure, the user 2 can trigger, or accept, in step S3, an offer in several ways, for example by:
entering a code into an app (application program) on a the mobile device 2b;
scanning a quick-read (OR) code;
clicking an internet url link.

The action also transfers the user's 2 position A and details of the vehicle 2a to allow the computer-based apparatus 1 to calculate the offer value. This is carried out in the calculation unit 1c, see FIG. 1. The triggering process involves:
the user 2 passing identification items to the computer-based apparatus 1, step S4, for example name, account number and mobile device 2b identification number,
the user 2 passing current measurements of sensor data to the computer-based apparatus 1, step S5, including information regarding the current position A and optionally other items such as other sensor data and energy usage data.

Such sensor data can be in the form of monitoring data such as the state of charge (SOC) and state of health (SOH) of the vehicle's 2a batteries. Also, data related to the vehicle's energy usage can be provided, i.e. an indication of the rate of which energy is used whilst the vehicle 2a is being driven. This could be from historic data as measured by a sensor, or a set value for a given vehicle model and battery model which is stored in a look-up table.

The next step in the process is that specific offers are calculated and presented to the user 2, step S6. Once the computer-based apparatus 1 has the data described above with reference to steps S4 and S5, it calculates either one or several specific offers, each of which includes information related to:
the specific offer ID(s);
the specific position(s) at which the offer objective can be fulfilled;
the offer value(s); and
any additional offer conditions.

Some or all of the individual items in the specific offers are presented to the user 2. Potentially a number of specific offers would be available to the user 2, and all or a selection of these are presented to the user 2.

According to an optional aspect of the disclosure, the offer value can be calculated in the following manner, see step S6a. An estimation using the GIS (Geographical Information System) database 1d is carried out. This is done by calculating the route from the first position A to the second position B using information in the GIS database 1d. From this calculation, the distance that will be travelled can be determined. Once this is known, the computer-based apparatus 1 can either make a general estimate or access the vehicle's 2a other sensor data to estimate the vehicle's 2 energy usage per unit of distance, or estimate the energy tariff of the user 2, or determine the actual energy tariff, either by using information provided by the user 2 or by information supplied by an energy supplier 5. The cost of energy is then the number of units of distance travelled times the energy consumed per unit of distance times the cost per unit of energy.

According to a further aspect, also indicated in step 6a, the offer value can be calculated by estimating, and then verifying the energy use of the battery of the vehicle 2a. By first estimating energy usage using the method as described above, then tracking the actual energy use as the vehicle is driven to the second position B. Using this method the amount of energy used is determined. The estimated offer value can be used to prepare the specific offer, then this estimated value is replaced by an actual value to set the offer value that will be redeemed by the user 2.

The actual cost of energy used can be estimated by taking the number of units of energy consumed and then multiplying this value by the estimated or known cost per unit of energy as charged by the user's 2 energy supplier 5.

For both aspects above, the cost of the outward-bound and return journey may be estimated by multiplying the cost of the outward bound journey by two.

Consequently, step 6a in FIG. 2 indicates certain parameters which, according to aspects of the disclosure, can be used taken alone or in combination to provide information for calculating the offer value, as indicated in step 6.

Next, a process is performed in which the user 2 initializes a specific offer, see step S7, which means that the user 2 selects one of the specific offers which have previously been presented by the offering entity 3 (alternatively, this can be selected automatically), and informs the computer-based apparatus 1 of the choice offer.

This means also that the offering entity 3 has provided the necessary information, step S8, related to the offer objective which the user 2 accepts to fulfill, i.e. to perform the necessary actions in order to obtain the compensation associated with the offer. According to an aspect, these actions include travelling from the first position A to the second position B and purchasing a product or service from the offering entity 3.

The computer-based apparatus 1 provisions the necessary process and data to allow the specific offer to be fulfilled. In the following, an aspect regarding how the process and data would be provisioned will be presented:

a. The user 2 ID and specific offer ID would be stored in a memory in the computer-based apparatus 1.
b. The user 2 ID and specific offer ID would be stored in each point of sale terminal capable of processing the fulfillment of the offer.
c. The user 2 ID and specific offer ID would be stored in a memory in the mobile device 2b.
d. An encrypted code can be sent to the user 2 containing the details of the specific offer.

The user 2 selects one of the specific offers, or this can be selected automatically, and informs the computer-based apparatus 1 of this choice. Once this is done, the computer-based apparatus 1 provisions the necessary process and data to allow the specific offer to be fulfilled.

In the following, certain example embodiments as to how the process and data would be provisioned will be described.

a. The user 2 ID and specific offer ID would be stored in a memory in the computer-based apparatus 1.
b. The user 2 ID and specific offer ID would be stored in each point of sale terminal associated with the offering entity 3 which is capable of processing the fulfillment of the offer.
c. The user 2 ID and specific offer ID would be stored in a memory in the mobile device 2b.
d. An encrypted code can be sent to the user 2 containing the details of the specific offer.

The next step in the process is that the user 2 fulfills the offer objective, step S9, i.e. fulfills all the requirements stated in the specific offer. In the following, certain example embodiments as to how an offer objective would be fulfilled will be described.

a. The user 2 buys a specific item or group of items.
b. The user 2 buys an item or group of items above a certain price.

In order for the offer objective to be fulfilled, the user 2 has to be in the second position B. After this, the computer-based apparatus 1 associates fulfillment of the offer objective with the specific offer.

Each of the requirements made of the user 2 outlined in the specific offer are verified as having being completed by the offering entity 3. In the following, certain example embodiments to associate the specific offer with the fulfillment of the offer objective will be described.

a. At the time the offer objective is fulfilled (for example by purchasing a specific item) the point of sale equipment associated with the offering entity 3 gathers the user 2 ID (for example by the user 2 presenting their user ID to the point of sale operator, by the point of sale pairing with the user's 2 mobile device 2b, or by an association of the user ID with the information required to process an electronic payment). The user 2 ID is then checked against any pending offers stored.
b. An encrypted code is passed from the user 2 to the point of sale or checkout terminal. The requirements of the offer are compared with the purchases made by the point of sale and thus whether the offer has been fulfilled or not is known.
c. A point of sale operator decides whether the offer requirements have been met and manually enters the decision into the system.
d. A connection is made with the GPS 4 and the GPS 4 informs the computer-based apparatus 1 if it has reached the second position B.

When the offer objective has been fulfilled, the offering entity 3 transfers the offer value to the user 2, indicated in FIG. 2 with step S10. In the following, certain example embodiments as to the transfer of the offer value to the user 2 will be described.

a. The offering entity 3 provides the user's 2 identity and a credit to the user's 2 energy supplier. The energy supplier then credits the user's 2 account with that amount.
b. The offering entity 3 provides a purchase order to the energy supplier 5 for the amount of the offer value. The energy supplier then charges the offering entity 3 for that amount whilst removing the charge from the user's 2 account.
c. The offering entity 3 gives a cash equivalent of the offer value to the user 3.
d. The offering entity gives a voucher to the user 2 that can be redeemed with the energy supplier 5.

Depending on the construction of the specific offer, the offer may close or allow the user 2 to repeat the process. Optionally, the user 2 confirms the offer value that met the actual cost of meeting the offer objectives.

By tracking the actual energy expended and knowing the offer value, the user 2 can assess whether the offer value covered the actual costs, and if a variation exists a correction can be made. In the following, an example embodiment to allow the user 2 to check if the offer value met the actual costs will be described.

A method could be provided to allow the user 2 to monitor the vehicle's 2a energy usage whilst travelling to the second position B. This in conjunction from energy tariff data from the energy supply database 1e can be used to calculate the actual cost. If the transfer of the offer value then has an associated identifier, a mobile device application could check that the two values match or are within a certain tolerance.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

1. A method, performed in a computer-based apparatus for providing information related to an offer to at least one mobile user, being positioned at a first position, from an offering entity being positioned at a second position, said offer being associated with a compensation to the user upon fulfillment of an offer objective by said user; said method comprising:
providing information related to said offer objective from said offering entity to said user;
detecting whether said offer objective has been fulfilled by said user;
transferring said compensation from said offering entity to said user when said offer objective offer has been fulfilled by said user;
said compensation being transferred in the form of a credit related to a calculated offer value corresponding to the cost for said user for travelling between said first position and said second position.

2. The method according to claim 1, further comprising:
calculating said offer value by taking into account a cost of energy for said user to travel between said first position and said second position.

3. The method according to claim 2, further comprising:
calculating said offer value by taking into account a cost of charging an energy source being associated with said user.

4. The method according to claim 1, further comprising:
calculating said over value by taking into account a distance for said user to travel between said first position and said second position.

5. The method according to claim 4, further comprising:
determining said distance by using navigational information from a GPS system indicating the position of said user and indicating the position of said offering entity.

6. The method according to claim 1, wherein said step of providing information related to said offer objective to said user includes transmitting information related to the second position.

7. The method according to claim 1, further comprising:
determining whether said offer objective has been fulfilled upon arrival of said user at said second position.

8. A computer-based apparatus for providing information related to an offer to at least one mobile user, being positioned at a first position, from an offering entity being positioned at a second position, said offer being associated with a compensation to the user upon fulfillment of an offer objective by said user; said apparatus comprising:
a communication unit configured for mediating information related to said offer objective between said user and said offering entity and related to said compensation from said offering entity to said user when said offer objective has been fulfilled by said user;
a control unit configured for detecting whether said offer objective has been fulfilled by said user; and
a calculation unit configured for determining a calculated cost for said user for travelling between said first position and said second position, said offer value being transferred to the user in the form of a credit of said calculated cost.

9. The apparatus according to claim 8, wherein said calculation unit is configured for calculating said offer value by taking into account a cost of energy for said user to travel between said first position and said second position.

10. The apparatus according to claim 8, wherein said calculation unit is configured for calculating said offer value by taking into account a cost of charging an energy source being associated with said user.

11. The apparatus according to claim 8, wherein said calculation unit is configured for calculating said offer value by taking into account a distance for said user to travel between said first position and said second position.

12. The apparatus according to claim 11, wherein said communication unit is configured for communicating with a GIPS system indicating the position of said user and indicating the position of said offering entity, wherein said calculation unit is configured for determining said distance by using navigational information from the GPS system.

13. The apparatus according to claim 8, wherein said communication unit is configured for transmitting information related to the second position to said user.

14. The apparatus according to claim 8, wherein said control unit is configured for determining whether said offer objective has been fulfilled upon arrival of said user at said second position.

15. An electric vehicle comprising an apparatus according to claim 8.

16. A mobile communication unit comprising an apparatus according to claim 8.

17. A computer program, comprising computer readable code which, when run on an apparatus, causes the apparatus to perform the method as claimed claim 1.
